(19) United States
(12) Patent Application Publication
(10) Pub. No.: US 2008/0196096 A1
(43) Pub. Date: Aug. 14, 2008

(54) Methods for Extending a Security Token Based Identity System

(76) Inventor: Amiram Grynberg, Neve Efrayim Monoson (IL)

Correspondence Address: AMIRAM GRYNBERG, 24 RIMON ST, NEVE EFRAYIM MONSON, 60190, omitted

(21) Appl. No.: 12/025,818

(22) Filed: Feb. 5, 2008

Related U.S. Application Data
(60) Provisional application No. 60/889,551, filed on Feb. 13, 2007.

(51) Int. Cl. G06F 21/00

(52) U.S. Cl. 726/9

(57) ABSTRACT

Methods for extending a security token based identity system to handle legacy, non security token identity data requests, by mapping non supported requests to supported ones.

### CROSS REFERENCE TO RELATED APPLICATIONS

Provisional Application Ser. No. 60/889,551, the benefit of which is hereby claimed under 35 U.S.C. .sctn.119 (e), and wherein said provisional application is further incorporated herein by reference.

### BACKGROUND OF THE INVENTION

Using security tokens as a basis for managing user identity is technically well established with the publication of the web services family of security specification (WS-*), notably WS-Security, WS-Trust, WS-MetadataExchange and WS-SecurityPolicy. WS-* documents are available from http://www.oasis-open.org.

CardSpace by Microsoft, is an identity system framework which defines rules of engagement for various components of an identity system based on WS-* standards. There are other identity infrastructures like Open ID, but a CardSpace client is integrated within the Vista operating system making it a good candidate to successful long term adoption.

Definitions of Identity System Components:

Identity Data—a list of identity related data items like name, address, user name, password etc.

ST—Security token containing a signed list of claims asserted to by a Security Token Service (STS).

Information Card—An instance of Identity Data specification which defines among other things, a card ID, list of claims that the card issuer will support, and the identity of the card issuer.

STS—Security Token Service. A service that issues an ST (RSTR) in response to a request (RST).

RP—Relying Party. A service or server that requires a client to prove some identity related claims before it is granted access to said service.

IS—Identity Selector. A client program that facilitates the selection of an Information Card from a collection of cards so that it would match the requirements of a RP. IS uses data stored in a selected RP to request a ST from an IP.

IP—Identity Provider which implements a Security Token Service (STS), also known as Information Card Issuer. A service that provides a client with a signed security token (ST), containing claims verified by the service. IP can also provide an Information Card to be imported into an IS. An IP uses an associated persistent database for its operation.

Microsoft's CardSpace specification documents are incorporated here by reference. http://www.identityblog.com/wp-content/resources/profile/Infocard-Profile-v1-Guide.pdf and http://netfx3.com/content/WindowsCardspaceHome.aspx.

From a user's experience point of view, having a unified and single experience when responding to identity data requests is of a paramount importance. Since many websites and services use other protocols for identity credentials, predominantly HTML form based input; it would be desirable if a single user interface (UI) client could handle a multitude of protocols even if that client was not originally designed to support such protocols.

However, products like CardSpace do not currently handle other protocols.

An open source project known as Higgins (http://www.eclipse.org/higgins) tries to address this issue by providing a web browser adaptor that invokes different types of clients based on the type of protocol detected. However, such a solution fails to address two important issues. The first being the use of a single UI for all protocols and the second being a potential collision with CardSpace's own client software when the two coexist.

Thus it would be advantageous to have a product that embodies methods wherein a single pre-installed UI client would serve as Identity Selector for multiple identity protocols. Furthermore, it would be desirable for such a product to be based on the ubiquitous CardSpace UI where available.

Furthermore, it would be beneficial to users if identity data used by such a product is automatically captured and imported into the system.

### SUMMARY OF THE INVENTION

The present invention is about extending identity management products to facilitate a unified handling of legacy requests. Although the preferred embodiment focuses on Microsoft's CardSpace architecture and products, the disclosed concepts may be applied to other similar technologies.

In essence, the disclosed methods deal with handling of legacy requests by a standard Identity Selector.

Methods for extending an Identity Selector Client (IS) to seamlessly handle legacy identity data requests are disclosed. Said method comprising the following steps:

Intercepting a legacy request for identity data. For example, an HTML page containing fill-able form fields.

Emulating a Security Token request wherein legacy identity data is mapped to ST identity data; and directing IS to use an Extended Identity provider (XIP) to provide said data. This may be accomplished by adding an HTML code to an HTML request wherein such code would trigger the resident IS, or by directly invoking IS by an extended browser.

Passing a request from IS to XIP to provide a Security Token matching the request; and converting response ST identity data to Legacy identity data.

Finally, filling out the original form with converted data and submitting that form.

### BRIEF DESCRIPTIONS OF THE DRAWINGS

FIG. 1 describes an information flow for a standard ST based request from a Relying Party to Identity Provider and back.

FIG. 2 describes information flow for a simulated identity data request from a Relying Party that uses HTML forms.

FIG. 3 describes information structure for form based identity data request and security token identity data request.

### DETAILED DESCRIPTION OF A PREFERRED EMBODIMENT

Definitions of Extended Identity System Terms:

Legacy Request—a request for Identity Data in a standard HTML form and fields.

XBR—(extended BRowser) a browser (including extensions) that automatically handles both ST requests and also implements the methods of the present invention.

XIP—an extended IP that supports the methods of the present invention.

### Handling of Cardspace Requests

The present invention is about extending identity management products to facilitate unified handling of legacy requests. Although the preferred embodiment focuses on Microsoft's CardSpace architecture and products, the disclosed concepts may be applied to other similar technologies.

First, a typical CardSpace process is described. For a detailed description of CardSpace please see http://www.identityblog.com or http://netfx3.com/content/WindowsCardspaceHome.aspx.

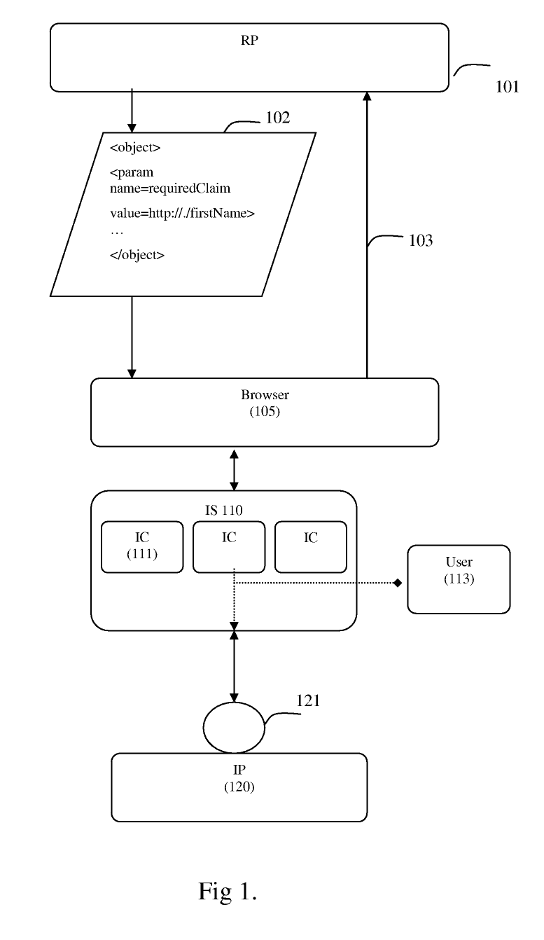

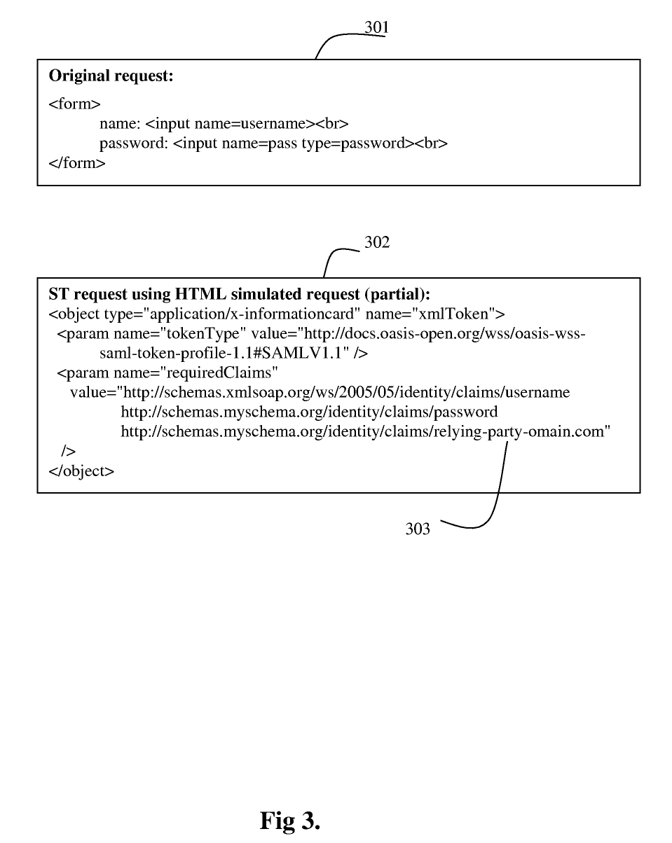

In FIG. 1 a CardSpace compliant browser (Internet Explorer 7 or Firefox with extension), detects a request 102, by a website (RP) 101 to receive, from said browser (with the help of user 113), a security token (ST) 103 which should include an authenticated set of requested claims 102. Request 102 is sent in a particular format that would trigger the CardSpace compliant parts of the browser (see also FIG. 3—302). Normal HTML forms and fields (FIG. 3—301) would not do it.

Following detection, a compliant browser 105 invokes an identity selector program (IS) 110, requesting that a compatible security token be returned by IS.

An IS 110, presents user 113 with a User Interface and prompts the user to select one of the identity cards 111. Usually, an IS will highlight cards which match a particular request.

Following selection, IS sends a request to the issuer of the card 120 (IP) through its security token service (STS) 121 to authenticate the current user and return the requested ST.

IP authenticates the current user creates a ST, signs it and returns it to IS 110. From IS the token is sent back to the requesting browser 105 which embeds the requested data within a response 103 and sends that response back to the RP 101.

### Handling of Legacy Requests

From a user's point of view, he or she would rather have a unified user interface UI experience when logging in to websites. However, since most websites do not use ST requests, it would be advantageous to emulate a ST so that a user would experience the same UI when logging in to websites, even if such websites do not use Security Tokens.

For the purpose of the present invention, it is assumed that a CardSpace compliant identity selector is installed on a user's machine.

The purpose of the present invention is to leverage such IS for carrying out legacy logins to websites which only support user name/password forms (or similar legacy schemes).

Following is a short description of the information flow for a CardSpace compliant token processing when using HTML forms requests.

IS will not be triggered if the incoming form from a RP does not contain the required HTML tags. More specifically, it will not trigger IS when the incoming request contains an HTML form with the requested data as form fields (FIG. 3 301) and not as a ST request markup code (FIG. 3—302).

To facilitate the new functionality, several components are added to the identity management system. It would be clear to those skilled in the art that those components may be implemented in a variety of ways. What is important is the methods implemented by those components.

Thus, in accordance with the present invention, as a first step, there is a need to intercept the incoming legacy request from a RP and cause it to trigger an existing IS. This can be done by extending the browser. Such extension would provide the requested functionality. We will denote such an extended browser by XBR. It is assumed that XBT also supports ST requests.

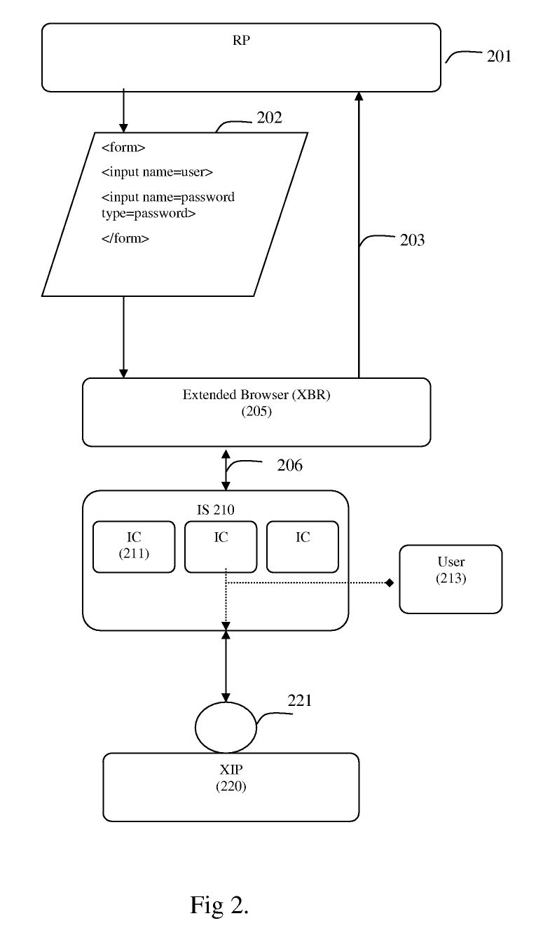

In FIG. 2. XBR 205 detects an HTML page with fill-able form 202 containing identity related fields.

Two methods are disclosed for triggering IS:

In a first method, XBR modifies the original HTML page so that it will now trigger IS. This can be done by adding a new <object> tag to the page, formatted as a ST compatible HTML code (see FIG. 3—302), causing the browser to react to that code as if it came from RP (“HTML simulated request”).

Alternatively, in a second and preferred method, IS is invoked directly from XBR using application program interface (API) of IS and submitting a “direct simulated request”.

However, triggering IS is not enough. IS should receive from XBR a simulated request 206 in which the original form fields 202 are mapped onto ST compliant ‘required claims’. Furthermore, it should be triggered in such a way, so as to cause it to pass the simulated request to a cooperating, extended Identity Provider (XIP) that can respond to the requested information—such as user name and password.

This can be done by adding entries in said simulated request.

Thus, a simulated request includes a list of claims that the XIP should verify. For each field in the HTML form for which XBR wants to receive identity data from said XIP, it will insert a requested claim in the simulated request.

Furthermore, XBR will direct IS to request the signed ST only from XIP using the “issuer”, “issuer policy” of the simulated request. Alternatively, other artificial claims can be added that will only match Information Cards managed by XIP (see below).

After being triggered, IS presents a user with a list of compatible Information Cards. Compatible cards are defined as ones which contain the requested claims and are supported by the specified IP.

In a first embodiment, IS holds a single card representing all RPs which use legacy requests of the username/password authentication form. In such a case, XIP would use the RP identifier in the requested ST to single out a saved record or a group of saved records of user credentials related to RP.

Alternatively, in a second embodiment, each saved record of user credentials in XIP has an associated Infocard in IS. With such an embodiment, selecting a card in IS infers a particular saved record.

An issue with the second embodiment is that, users who have many accounts on the web, may create too many cards related to XIP, thus cluttering IS. To facilitate a quick discovery and selection of a matching Infocard, from the many Infocards related to XIS, an artificial claim is added to each said card wherein the claim name is derived from RP. For example, if RP is www.relying-party.com, a claim name could be ‘http://schemas.myschema.org/identity/claims/relying-party.com’. When XBR submits a request for ST from IS, it then specifies ‘http://schemas.myschema.org/identity/claims/relying-party.com’ (see FIG. 3—303) as a required claim, causing the list of matching cards to narrow down to only those which support such claim.

After a card is selected, a ST request is passed on by IS to XIP 220 with a selected Card ID.

It should be noted that IS is not aware of the extensions, thus user experience is preserved.

XIP can reside on the same computer. Preferably, it can be made part of the browser extension that was used to intercept the original request. However, an XIP can also reside on a remote computer.

A standard way to access XIP is via an http request using end points defined by the selected Infocard. However, it should be clear that future development of direct invocation of the STS by IS are possible and therefore are covered by the present invention.

XIP provides for standards based STS 221. Once XIP receives a ST request identified by a card ID, it retrieves the related identity data from its persistent store, encodes that information as a security token (ST) and returns the information to IS. XIP may require a user to authenticate to XIP before releasing a requested ST.

In a preferred (and standard) embodiment of communicating data from XIP to XBR, IS passes ST 203 back to XBR 201.

However, there are several other methods that can be used to communicate identity data from XIP to XBR.

If, for example, XBR and XIP happen to share the same process executing on a host computer, for example, passing that information is a simple matter of memory sharing.

Once the response ST arrives at XBR, two things can happen, depending on the method used to simulate a CardSpace request.

When using a direct simulated request, XBR extracts claims data from the response ST and auto-fills the original form fields as requested by RP. It then submits said form to RP with the requested data. Filling form fields by itself is well known in the art of password managers.

However, when using the HTML simulated request, it is the browser which originally triggered IS in response to the ST HTML pattern, which receives the response. Said browser, in accordance with its standard behavior, would automatically submit that information to RP as a security token embedded within a form. This is not good for the purpose of the present invention, as the relying party (RP) does not understand such tokens.

Thus, in accordance with the present invention XBR captures such submission event and suppresses submission of a ST form. Instead, XBR replaces it with submission of the original form requested by the RP (This contains username/password fields for example) wherein the original form is first filled with claims extracted from the response token.

Once the original form is filled XBR (or the user) can submit it to RP.

Another aspect of the present invention is one of setting up Information Cards in IS and storing initial identity data by XIP.

Manually creating a new information card and entering identity data is one way to accomplish that. Alternatively, and preferably, capturing such information during login operation and using it during a later identity data request is disclosed.

In accordance with the present invention, forms filled with legacy identity data, submitted to a website (RP), is captured by XBR using well known techniques such as the ones employed by current day password managers. Said captured data is then passed on to XIP.

Passing captured data from XBR to XIP can be done out-of-band using shared memory or other communication means between two cooperating programs.

In some cases, new user registration data can be generated by XIP directly. This may happen when a website, during sign-up operation, allows for user created user name/password/email to determine the login credentials. In such cases, XIP only requires partial or no data at all from XBR and it can generate the required data on its own.

XIP then associates a new card with the just captured identity data and saves such data to persistent storage.

As a next step, XIP exports a related Information Card to IS.

What is claimed is:

1. A method for extending ST based identity system to transparently handle non ST legacy identity data request, from a Relying Party (RP), via a matching Identity Provider (XIP), comprising the steps of:
Intercepting a non ST based request for legacy identity data from RP comprising forms with fields;
Simulating a ST request, directed at XIP, wherein form fields are mapped to ST identity data claims;
Triggering an Identity Selector (IS) responsive to said simulated request;
Receiving response ST from IS and converting its asserted claims to non ST identity data; and
Responding to RP with said converted data.

2. The method of claim 1 wherein the step of triggering IS is carried out by invoking IS via API and passing it a ST request.

3. The method of claim 1 wherein the step of responding to RP with said converted data, comprises:
Filling out of form fields with converted data;
Submitting said filled form to RP.

4. The method of claim 1 wherein the steps of Triggering IS comprises:
Triggering IS to present a user with Information Card Selection interface;
Enabling selection of only those Information Cards related to RP.

5. The method of claim 1 wherein legacy request and response are coded in HTML.

6. The method of claim 5 wherein the step of intercepting a non ST request comprises detecting a web page wherein said page includes a fill able form containing identity data fields.

7. The method of claim 5 wherein the step of triggering IS comprises modifying said web page to include a ST request in HTML code, simulating the non ST request.

8. The method of claim 7 wherein the step of receiving response from IS comprises:
Intercepting a submit event wherein response ST is sent to RP;
Canceling said event;
Converting asserted claims contained within said ST to non ST identity data.

9. A method for adding Information Cards to an Identity Selector (IS) referencing identity data stored in XIP, comprising the steps of:
Intercepting a non ST based request, from RP, for legacy identity data comprising forms with fields;
Capturing a response to RP for said request;
Communicating captured response to XIP;
Saving captured response by XIP; and
Exporting an Information Card, related to captured data, to IS.

10. The method of claim 9 wherein legacy request and response are coded in HTML.
